(19) United States
(12) Patent Application Publication
(10) Pub. No.: US 2009/0157369 A1
(43) Pub. Date: Jun. 18, 2009

(54) Fast and High-Throughput Search Engine for Materials for Lithium-Ion Batteries Using Quantum Simulations

(75) Inventors: Jun Li, Milbrae, CA (US); Deepak Srivastava, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: NanoExa,Inc., Burlingame, CA (US)

(21) Appl. No.: 12/334,170

(22) Filed: Dec. 12, 2008

Related U.S. Application Data
(60) Provisional application No. 61/013,928, filed on Dec. 14, 2007.

(51) Int. Cl. G06G 7/58

(52) U.S. Cl. 703/12

(57) ABSTRACT

Provided are methods and systems for determining the structure of a composite or solid solution material for an electrode in lithium-ion batteries. In one embodiment, a method is presented where a building-block database of hypothetical structures containing only one transition metal atom is constructed by use of quantum simulation. Then, a composite model set of structures containing two or more transition metal atoms is constructed by calculating a linear average of parent components from the building-block database of hypothetical structures to determine lattice constants and atomic coordinates of candidates. The composite model set is screened with a local order matrix to subclassify composite models into a subset, such that the composite models share the same property in local transition metal ordering. Still yet, a representative from each subset is selected and a quantum simulation on the representative models is performed to determine the structure of the material.

### CLAIM OF PRIORITY

This application claims priority from U.S. Provisional Patent Application No. 61/013,928, filed Dec. 14, 2007, and entitled “FAST AND HIGH-THROUGHPUT SEARCH-ENGINE FOR MATERIALS FOR LITHIUM-ION BATTERIES USING QUANTUM SIMULATIONS.” This provisional application is herein incorporated by reference.

### BACKGROUND

1. Field of the Invention

The invention relates to the use of quantum simulations to determine the structure of composite/solid solution cathode and alloyed anode materials.

2. Background of the Invention

Advanced batteries substantially impact the areas of energy storage, energy efficiency, hybrid and plug-in electric vehicles, power tools, laptops, cell phones and many other mobile electronic and entertainment devices. Rechargeable lithium-ion batteries offer the highest energy density of any battery technology and, therefore, are an attractive long-term technology that now sustains a billion-dollar business. At the materials level, over the last 30 years the major improvement in the performance of lithium batteries has been achieved through the discovery of new lithium cathode materials. LiTiS₂ was the first commercialized cathode material for lithium batteries in the 1970s. LiCoO₂ is currently the most active cathode material used in lithium-ion batteries since its discovery in the early 1990s.

However, the safety and high cost of cobalt significantly limits its application to the emerging high capacity and high power battery markets. Additionally, the low charge and discharge rate capability is a well-known problem of lithium-ion batteries (Kang et al., Science, 311: 977, 2006). Recent efforts in both industrial and academic attempts to overcome these limitations have been focused on compositional modification of LiCoO₂, mainly by infusion with other transition metal elements (Kang et al.; Shaju et al., Adv. Mater., 18: 2330, 2006; Thackeray et al., U.S. Pat. No. 6,680,143), or new architectures for advanced composite materials for cathodes.

There has been a similar interest in the development of an advanced anode using alloyed materials since commercialization of the graphite anode accompanying the LiCoO₂ cathode in the 1990s (Winter et al., Chem. Rev., 104: 4245, 2004). Alloyed materials for an advanced anode and composite materials for an advanced cathode are the mainstream approach for next generation Li-ion battery technology. Both have the same nature of disorder, in contrast to the well-defined crystalline structures of LiCoO₂ and graphite.

Searching for new materials by empirical experimental efforts is time-consuming and expensive. Significant efforts are currently underway, mainly in the academic community and Department of Energy laboratories to use quantum simulations on high performance computers to accelerate the search for new and better materials for the battery industry. The goals of these efforts are: 1) to reduce the costs of the research and development of a product; 2) to accelerate the time-cycle for new material in a product from laboratory to market; and 3) to increase the scope of systematic improvements in material designs. Quantum Simulations (QS), based on the first-principles density functional theory (DFT) or its equivalent, provide reliable computer simulations to predict on atomic-scale the properties of currently known battery materials for cathode, anode and electrolyte. The accuracy of the QS based predictions of materials properties has been proven in a broad range of applications in semiconductor to pharmaceutical industry.

It is in this context that embodiments of the invention arise.

### SUMMARY

In one embodiment, a method of determining the structure of a composite or solid solution material for a cathode in a lithium-ion battery is presented. The method comprises:

constructing a building block database of hypothetical structures containing only one transition metal atom in their crystal unit cells by use of quantum simulation; constructing a composite model set of structures containing two or more transition metal atoms by calculating a linear average of parent components from the building block database of hypothetical structures to determine the lattice constants and atomic coordinates of candidate composition models, the structures being nearby a total energy minimum;

screening the composite model set by employing a local order matrix to subclassify each composite model into a subset such that the composite models in each subset share the same property in local transition metal ordering, and selecting a representative model from each subset; and

performing quantum simulation on at least one of the representative models to determine the structure of the composite or solid solution material.

Another embodiment presents a method of determining the structure of a composite or solid solution material for a cathode in a lithium-ion battery. The method comprises:

constructing a composite model set of structures containing two or more transition metal atoms by calculating a linear average of parent components from a building block database of hypothetical structures containing only one transition metal atom in their crystal unit cells to determine the lattice constants and atomic coordinates of candidate composition models, the structures being nearby a total energy minimum;

screening the composite model set by employing a local order matrix to subclassify each composite model into a subset such that the composite models in each subset share the same property in local transition metal ordering, and selecting a representative model from each subset; and

performing quantum simulation on at least one of the representative models to determine the structure of the composite or solid solution material.

In yet another embodiment, a method of determining the structure of an alloyed anode material in a lithium-ion battery is presented. The method comprises:

constructing a building block database of hypothetical structures containing only one active backbone element in their crystal unit cells by use of quantum simulation;

constructing a composite model set of structures containing two or more active backbone elements by calculating a linear average of parent components from the building block database of hypothetical structures to determine the lattice constants and atomic coordinates of candidate composition models, the structures being nearby a total energy minimum;

screening the composite model set by employing a local order matrix to subclassify each composite model into a subset such that the composite models in each subset share the same property in local active backbone element ordering, and selecting a representative model from each subset; and

performing quantum simulation on at least one of the representative models to determine the structure of the alloyed anode material.

In still another embodiment, a method of determining the structure of an alloyed anode material for an electrode in a lithium-ion battery is presented. The method comprises:

constructing a composite model set of structures containing two or more active backbone elements by calculating a linear average of parent components from a building block database of hypothetical structures containing only one active backbone element in their crystal unit cells to determine the lattice constants and atomic coordinates of candidate composition models, the structures being nearby a total energy minimum;

screening the composite model set by employing a local order matrix to subclassify each composite model into a subset such that the composite models in each subset share the same property in local active backbone element ordering, and selecting a representative model from each subset; and

performing quantum simulation on at least one of the representative models to determine the structure of the alloyed anode material.

Other methods, features and advantages of the present invention will be or become apparent to one with skill in the art upon examination of the following detailed descriptions. It is intended that all such additional methods, features and advantages be included within this description, be within the scope of the present invention, and be protected by the accompanying claims.

### BRIEF DESCRIPTION OF THE DRAWINGS

The invention may best be understood by reference to the following description taken in conjunction with the accompanying drawings in which:

FIG. 1 shows a schematic diagram of the algorithm for designing and optimizing solid-solution/composite materials for lithium-ion batteries using quantum simulations.

FIG. 2 shows the energy surface of layered LiMnO₂ determined by quantum simulations.

FIG. 3 shows alternate models for optimizing the structure of Li(CoNiMn)_{1/3}O₂.

FIG. 4 shows the configuration distribution statistics for optimizing the structure of Li(CoNiMn_{1/3}O₂.

FIG. 5 depicts a computer environment for implementing embodiments of the invention.

FIG. 6 illustrates a flow chart for a method of determining the structure of a composite or solid solution material for a cathode in a lithium-ion battery.

### DETAILED DESCRIPTION

Before the present compositions and methods are described, it is to be understood that the invention is not limited to the particular methodologies, protocols, assays, and reagents described, as these may vary. It is also to be understood that the terminology used herein is intended to describe particular embodiments of the present invention, and is in no way intended to limit the scope of the present invention as set forth in the appended claims.

It must be noted that as used herein and in the appended claims, the singular forms “a,” “an,” and “the” include plural references unless the context clearly dictates otherwise.

Unless defined otherwise, all technical and scientific terms used herein have the same meanings as commonly understood by one of ordinary skill in the art to which this invention belongs. All publications cited herein are incorporated herein by reference in their entirety for the purpose of describing and disclosing the methodologies, reagents, and tools reported in the publications that might be used in connection with the invention. Nothing herein is to be construed as an admission that the invention is not entitled to antedate such disclosure by virtue of prior invention.

As used herein, the term “total energy minimum” is an equivalent term for “structural stability” and indicates synthesis feasibility as commonly understood technical and scientific terminology.

As used herein, the term “local order matrix” is a measurement of the like-elements distribution near transition metal elements or active backbone elements in distance. This includes the first nearest neighbors, the second nearest neighbors, and even higher order nearest neighbors if needed.

As used herein, the term “linear average” is the commonly used math expression xₐᵥₑ=(Σxᵢ, where i ranges from 1 to n)/n, where xᵢ is the i-th component of the n-parent structures.

Two unique difficulties limit the application of Quantum Simulations (QS) to search and optimization for lithium-ion battery materials on a regular basis: 1) the complexity of compositional modification and ensuing solid solution or composite structure determination; 2) the large number of degrees of freedom and complex interactions in transition metal elemental species in solid solution and composite materials.

The possible schemes to modify a composition are numerous. For example, to replace Co in LiCoO₂ by m-elements of the first row transition metals could have 10^{m} possibilities (total combination of m-members from 10 different elements). The experimental techniques can only control the relative mole ratio of compositions; the individual atoms in solid solution materials cannot be determined by regular crystal structure characterization methods. Therefore, the detailed atomic arrangement is at large for a given ratio solid solution. This hinders the assessing of material property by QS.

Unlike semiconductor elements, the electronic structures of transition metals are much more complex and demand higher accuracy QS. Due to the cubic scaling of the time to the number of atoms in the material models, the QS for big models on a first-principles basis remain a formidable task even for materials containing very simple elements. For example, in recent highly accurate modeling of a carbon-based system with 180 atoms, the computational time to determine the binding energy was 1500 CPU hours (or 63 CPU days) using supercomputers (Williamson et al., Physical Review Letters, 87: 246496, 2001). Modeling solid solution or composite materials including transition metal elements for battery applications inevitably requires large supercells that could contain from several tens to hundreds of atoms in thousands of combinatorial mixtures. For example, in recent studies, a supercell with 511 atoms has been used to model a dilute concentration of vacancies in LiₓCoO₂ (x<1%) (Marianetti et al., Nature Materials, 3: 627, 2004).

The principle of material modeling by QS is based on the trial and error strategy to search a candidate structure located on a total energy minimum in a multi-dimensional space spanned by 6 lattice constants and 3N coordinate variables of N-atoms per unit cell. However, to deduce the coordinates of a possible structure starting with a random arrangement of atoms is a computationally demanding task, and currently impossible for complex materials. The efficiency of a high-throughput search of new materials using QS thus is dependent on the starting point on the multi-dimensional landscape or the hypothetical framework structures. The initial trial structures are often drawn from the researcher's empirical experience on the available data, and unfortunately there is no universal discipline to guarantee such a guess to be good for yet unsynthesized materials.

Thus, the main bottleneck in the use of QS for high-throughput search and optimization of advanced battery materials is the lack of an efficient and fast search algorithm that can avoid large utilization of computing resources and, more importantly, the time in the search and optimization of the complex composite and solid-solution materials in the multi-dimensional landscape. A reliable and efficient search strategy or algorithm will narrow down the likely range of candidate structures in the vast dimensional search space, and a fast high-throughput search engine using QS would be feasible for design and optimization of new lithium-ion battery materials for high power, capacity, and better stability applications in a timely manner.

Therefore, the present inventors have developed a search algorithm for fast and high-throughput design and optimization of solid-solution/composite materials for lithium-ion batteries using QS.

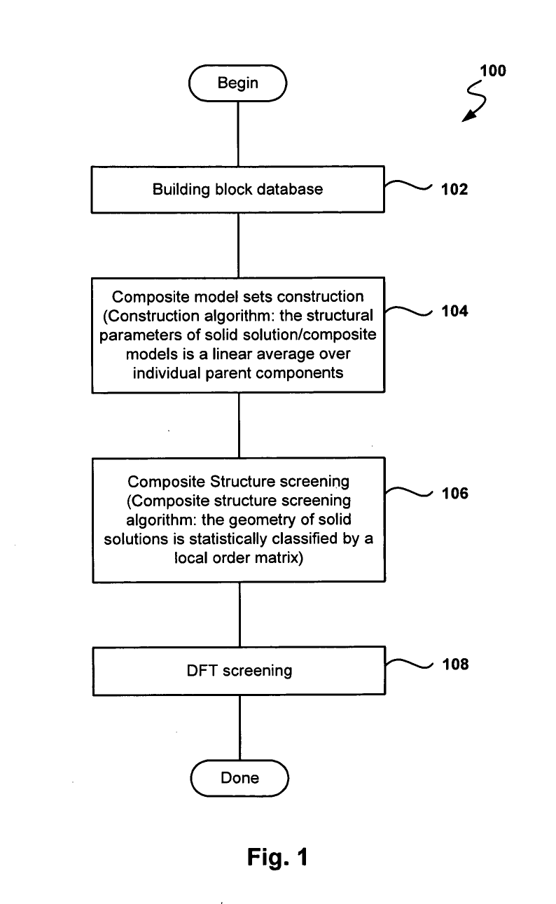

Our fast and high-throughput search algorithm is based on two facts: 1) advances in parallel computing platforms have made feasible highly accurate QS on small crystals which are very efficient on moderate computing resources on a regular basis, and 2) the crystal structures of the solid-solution and composite materials for lithium-ion battery applications are generally a derivative of the constitutive parent crystals. The algorithm is outlined in FIG. 1. Each module is further described below.

The first module 102 is construction of a building blocks database by highly accurate QS. Building blocks are “Lego Units”, which are a hypothetical structure containing only one transition metal atom in their crystal unit cells. This simplicity makes conventional, accurate QS search of new architectures possible in a timely manner. For example, replacing Co in layered (or spinel) LiCoO₂ or Fe in LiFePO₄ by other transition metal elements forms a new constitutive crystal to be used later as a component of solid solution models. The “Lego Units” may or may not be physically feasible or synthesized in the laboratory, and yet could serve as the computationally derived building blocks to determine the search criteria and domain of more complex solid solution or composite materials that are feasible and can be synthesized for lithium-ion battery applications.

The second module 104 is to construct a relatively complete big composite model set from “Lego Units” building blocks given by the first module. Our construction algorithm, as indicated in FIG. 1, determines the geometry of composite models, i.e., the lattice constants and atomic coordinates. The structure determined by this simple algorithm is within 1-2% of the corresponding QS optimized structure and experimental data. In other words, this algorithm creates initial structures nearby a total energy minimum without any ad-hoc input from experimental measurements. This significantly narrows the range of search landscape needed for the complex solid solution and composite materials.

The third module 106 is a quick structural screening. Because the model set from the second module often contains thousands of models (an example is given in the next section), a structural screening criterion is implemented to select representative models for a target composite ratio. Because of the nature of disorder, the structure of solid solutions is characterized statistically by a local order matrix, which measures the local chemical environment of a composite material. By tracking those matrix elements, the full model set can be classified into several smaller subsets groups. Representative models from each group form a compact set of target composite models.

The fourth module 108 is a final QS screening on representative models from the third module. Because the number of candidates has been significantly reduced in the third module and their initial structures are by construction nearby a total energy minimum as determined in the second module, the algorithm guarantees a fast and high-throughput search through a large model set.

The knowledge and information gained from the first, second, third and fourth modules is then iteratively used to (a) refine the predictive capability of the search algorithm and method, and (b) successively build larger and more complex secondary, tertiary and higher order structures depending upon the crystal structures satisfying the Lego-like building and compatibility criteria from smaller units.

Until now, materials discovery or design has largely been accidental and primarily driven by empirical experimental methods. The process of bringing an optimal material to market is quite slow in the battery industry. It took twenty years to move from LiTiS₂ to LiCoO₂ and another 15 years so far for design of a new generation of cathode material to occur. Designing advanced materials by computer will accelerate this process only if fast and high-throughput screening and predictions of new materials are possible in a cost and time-effective manner. One objective is to rapidly screen through hundreds to thousands of solid solutions or composite battery materials to short-list the few candidate materials which could be recommended for detailed investigations via either highly accurate QS or experimental synthesis and characterization methods. In one embodiment, a QS database of small “Lego like” structures is used with a screening algorithm for implementation in a fast and high-throughput search engine to significantly reduce design and optimization costs on one hand and shorten search time on the other.

The present method does not depend on any specific QS technique for building the searchable database of constitutive “Lego like” parent unit cell structures. Any existing QS can be embedded in building the core of the searchable database and the search engine. Accuracy of the search engine will depend on the accuracy of the QS technique used, and any advances in the QS techniques could be iteratively incorporated to further speed up the efficiency of the developed first generation search engine.

The present method does not depend on a specific electrode prototype and, therefore, minimizes the need of background experience.

The present search engine is easy to implement on moderate parallel computing platforms or clusters with current QS technologies, and does not essentially depend on the availability of high-power supercomputers for the largest size scale simulations. However, future advances in computer hardware and software technology as well as QS efficiency and accuracy can be iteratively incorporated to further improve the predictive accuracy and range of the developed search engine.

Once a complex composite or solid solution candidate structure is determined or predicted by the search engine, its physical and chemical properties can be reliably calculated by highly accurate QS. Specific application properties can be easily sought according to simple battery principles. For example, the calculation of formation energy offers a fast screening of material stability and feasibility of synthesis; the calculation of average open circuit voltage predicts a possible working voltage range for a candidate material.

The above discussion has focused on methods for determining the structure of a composite or solid solution material for an electrode in a lithium-ion battery. More particularly, such materials are typically used in a cathode. Transition metal atoms for the composite or solid solution materials include Sc, Ti, Zr, V, Nb, Cr, Mo, W, Mn, Fe, Co, Ni, Cu, Pd, Pt, Tc, Ru, Rh, Cd, Ag, Au, Y and Zn.

The methods described herein may also be used, for example, for determining the structure of an alloyed anode material in a lithium-ion battery. In such methods for alloyed anode materials, one merely substitutes an active backbone element in the structure of the alloyed anode material like the transition metal atoms in the composite or solid solution material for a cathode. Active backbone elements for the alloyed anode material include B, Al, Ga, C, Si, Ge, Sn, N, P, Sb, Bi, O, S, Se, Te, Zn, Cu, Ag and Au.

The use of such a computational approach in material designs without the need of experimental input should greatly accelerate the discovery of new classes of battery materials. Computational design of hypothetical new materials is possible, including the study of stability and prediction of properties, and is timely for the lithium-ion battery industry.

These and other embodiments of the present invention will readily occur to those of ordinary skill in the art in view of the disclosure herein, and are specifically contemplated.

The invention is further understood by reference to the following examples, which are intended to be purely exemplary of the invention. The present invention is not limited in scope by the exemplified embodiments, which are intended as illustrations of single aspects of the invention only. Any methods that are functionally equivalent are within the scope of the invention. Various modifications of the invention in addition to those described herein will become apparent to those skilled in the art from the foregoing description. Such modifications fall within the scope of the appended claims.

### EXAMPLE 1

Described here is a procedure to search a candidate structure using an example having a specific composition, i.e., Li(CoNiMn)_{1/3}O₂. The results prove the reliability of the algorithm and analyze the saving in computation costs. This validates the strategy as a fast and high-throughput search of candidate structures for lithium-ion battery materials.

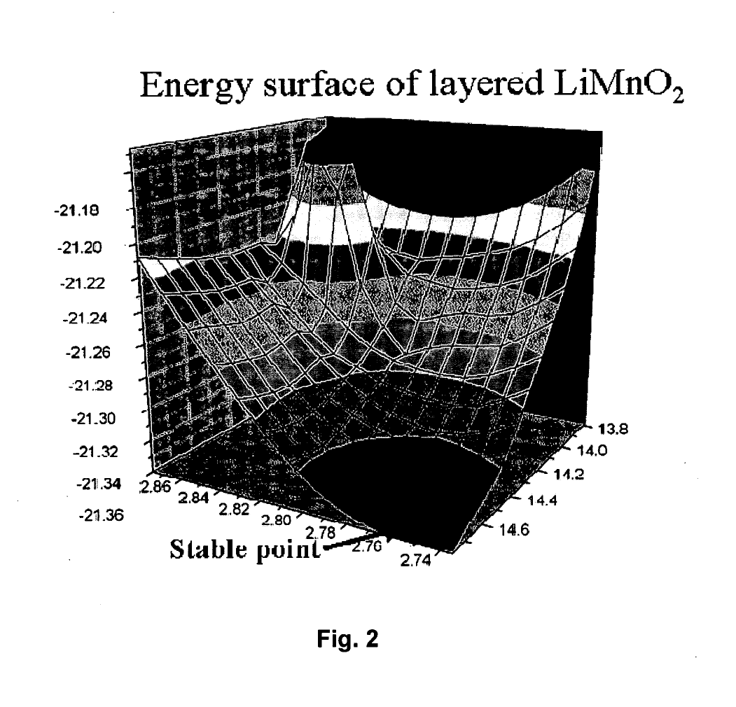

The target composition Li(CoNiMn)_{1/3}O₂ has three transition metal elements: Co, Ni, and Mn. Thus, the first operation determines structural parameters of three constitutive components: LiCoO₂, LiNiO₂, and LiMnO₂ by QS. The layered LiCoO₂ structure is defined by two lattice parameters, (i.e. a and c) and contains four atoms per unit cell. Since the crystalline parameters of LiCoO₂ and LiNiO₂ have been measured, experimental data are used as starting points in QS structural optimization. Table 1 compares QS optimized structures of LiCoO₂ and LiNiO₂ with their experimental data. The structural parameters of both models agree with measurements within about 1%. The LiMnO₂ has not been a reported synthesized material in layered phase; its lattice parameters and atomic positions are unknown. To determine a computational model of LiMnO₂, a trial-and-error strategy was used to locate a stable point on the energy surface. In this trial-and-error search, the structural parameters of optimized LiCoO₂ were used as the initial structure and Co was replaced by Mn. The corresponding energy surface is shown in FIG. 2. The computing costs of this scanning are listed in Table 2.

TABLE 1
Structural determination of Lego-like building by trial-and-error strategy

| | LiCoO₂ | | LiNiO₂ | | LiMnO₂ |
|---|---|---|---|---|---|
| | QS | Exp | QS | Exp | QS |
| Lattice a (Å) | 2.8473 (+1.1%) | 2.815 | 2.9108 (+1.1%) | 2.880 | 2.7614 |
| Lattice c (Å) | 13.9214 (−0.9%) | 14.05 | 14.1099 (−0.6%) | 14.190 | 14.7740 |
| Oxygen pos | 0.2603 (−0.1%) | 0.2606 | 0.2602 (+0.5%) | 0.259 | 0.2553 |

TABLE 2
QS computing costs

| | LiMnO₂ | Li(CoNiMn)_{1/3}O₂ model A |
|---|---|---|
| Starting structure | Optimized LiCoO₂ | Projected structure |
| System size | 4 atoms per unit cell | 36 atoms per unit cell |
| Landscape dimension | 14 | 110 |
| Average time per | 4.5 min | 101.3 hours or 6080 min |
| point | | |
| Total points passed | 197 | 20 |
| Total time for full | 880 min (16 h) cpu | 2026 hours |
| optimization | | |

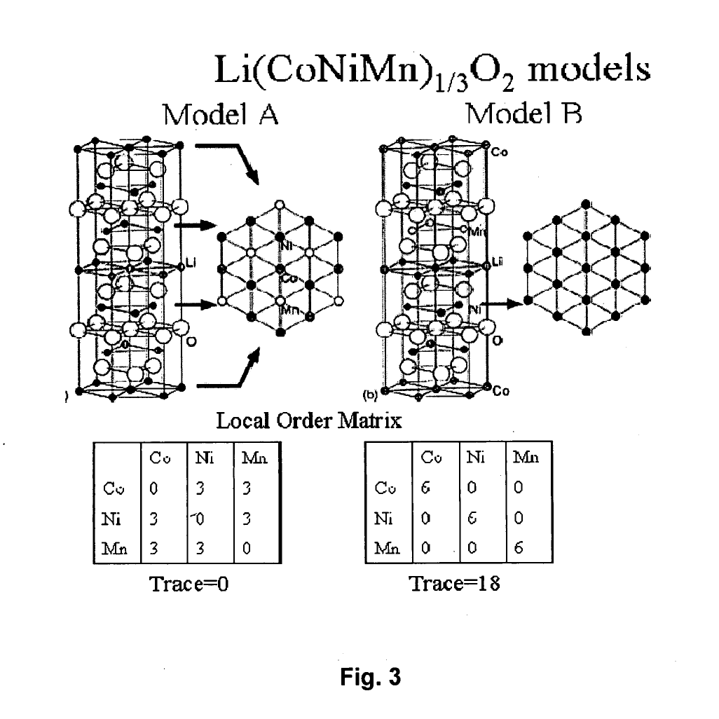

The second operation constructs a relatively complete set of large scale composite models that have an equal mole ratio among Co, Ni and Mn from the database determined in the foregoing paragraph. An R30 structure (shown in FIG. 3) was used as a template, which is a supercell of the layered LiCoO_{2.} The R30 structure has 36 atoms per unit cell and provides a template to simulate all the essential configurations having equal mole ratios of Co, Ni, and Mn atoms. Each configuration has a different distribution of Co, Ni and Mn atoms in the supercell and thus has different structural parameters that are determined from the aforementioned database by the construction algorithm indicated in FIG. 1. This construction algorithm results in 1680 different composite models. Two examples are illustrated in FIG. 3. The structures determined by the construction algorithm are near stable points on the multi-dimensional energy landscape. As presented in Table 3, the structures from the algorithm are within about 1-2% of QS optimized structures. This accuracy is also close to the QS error with respect to experimental structures as indicated in Table 1. This proves that the algorithm-derived structures can be used alone for further analysis or as a good starting point for QS optimizations.

TABLE 3
Validation of derived structures in comparison with optimized structures

| | | | Formation |
|---|---|---|---|
| | Lattice constant a | Lattice constant c | energy |
| Our Projected lattice | 2.8398 | 14.2684 | |
| QS optimized model A | 2.8827 (−1.5%) | 14.1067 (+0.3%) | −85 meV |
| QS optimized model B | 2.8401 (<0.1%) | 14.0579 (+1.5%) | +22 meV |

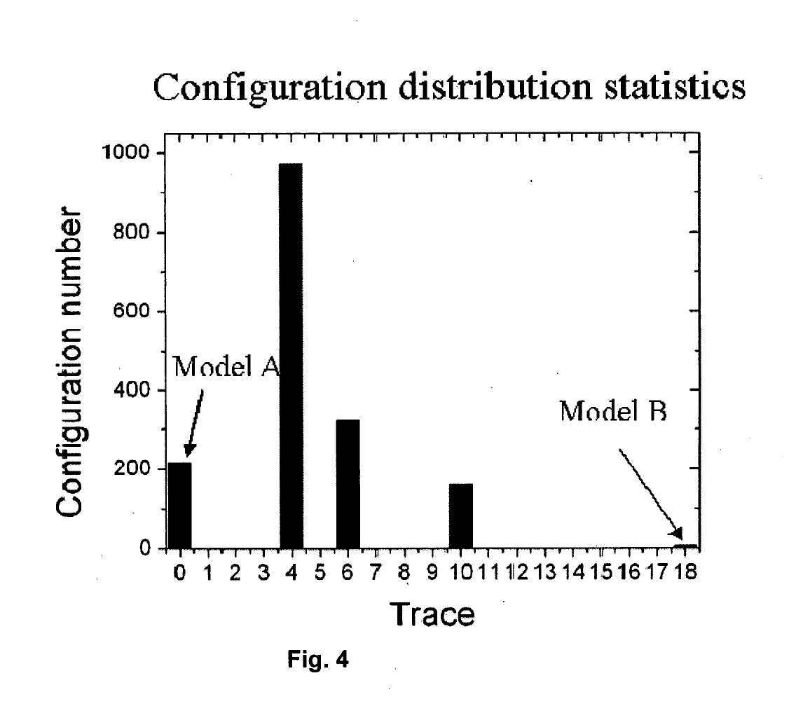

The third operation in structure screening is to find representative models from the model set given by the previous paragraph for the target composite material. Computing a single model of 36 atoms per cell is a moderate cost for QS. However, if computing one structure requires one day, a full scan of the 1680 models by QS would take 4.6 years. We employ a local order matrix to subclassify or screen the 1680 models. As shown in FIG. 3, different models have very different matrices, which measure the detailed transition metal atomic ordering. From the order matrix, the 1680 models are screened or classified into only five different groups as showed in FIG. 4. Models in the same group share the same property in the local transition metal ordering. Thus, only a limited number of representative models is needed for the target composite, Li(CoNiMn)_{1/3}O₂, without loss of generality.

The last operation performs QS on the representative models selected from the previous paragraph. The number of candidates has been significantly reduced and these hypothetical structures are located in a valley on the multidimensional energy landscape. These bring QS significant efficiency by scanning only those points near the bottom of the valley of the energy surface. Formation energy given by QS shown in Table 3 offers a further screening criterion. Because the model B has positive formation energy with respect to three individual components, it is not an energetically favorite phase. Therefore, among the choices A and B only model A could be further considered as a likely candidate for the battery materials. Using this approach, kinetically stable phases can be identified on the valleys of the potential energy at low temperature, while a more complex minimization of the free energy is required to identify high-temperature phases from the selected candidates. Furthermore, a similar “Lego like” building block approach can be used to a) introduce transition metals other than Co, Ni, and Mn in the mix and b) include all other phases of Li(M)O₂ type materials for optimization of required energy and power densities.

### EXAMPLE 2

Described here is a procedure to search a candidate structure using an example having a specific composition, i.e., Li(Co_{2/9}Ni_{4/9}Mn_{1/3})O₂. The results prove the reliability of the algorithm. This validates the strategy as a fast and high-throughput search of candidate structures for lithium-ion battery materials.

This target material has a different mole ratio among the constitutional transitional metal elements from the previous example. The first operation is the same as in Example 1. The second operation constructs a relatively complete set of large-scale composite models that have the mole ratio (2/9, 4/9, 1/3) among Co, Ni and Mn using the same R30 template. The construction algorithm indicated in FIG. 1 results in 1260 different composite models.

The next operation uses the local order matrix to classify the 1260 models into a smaller subset of eight representative models. Further QS is only needed for the eight representative models.

### EXAMPLE 3

Described here is a procedure to search a candidate using an example having a specific composition, i.e., Li(Fe_{1/9}Ni_{5/9}Mn_{1/3})O₂. The results prove the reliability of the algorithm.

This target material has a different mole ratio and constitutional transition metal elements from the previous two examples. Furthermore, LiFeO₂ is not an experimentally well-defined structure. Thus, the first operation of Example 1 is performed in order to determine the data needed in the following operations. The second operation constructs a relatively complete set of large-scale composite models that have the mole ratio (1/9, 5/9, 1/3) among Fe, Ni and Mn using the same R30 template. The construction algorithm indicated in FIG. 1 results in 504 different composition models. The next operation uses the local order matrix to classify the 504 models in a smaller subset of five representative models. Further QS is only needed for the five representative models.

Examples 2 and 3 illustrate the advantages of implementing the present search engine for varying the ratio and transition metal composition of Li-ion battery electrodes. This validates the strategy as a fast and high-throughput search of candidate structures for lithium-ion battery materials.

Finally, we give an estimate on the saving of time due to use of the algorithm-derived structures as a starting point in QS optimization. Table 2 gives a comparison of QS optimization between LiMnO₂ and composite Li(CoNiMn)_{1/3}O₂ Model A. Even though these two models are quite different, the path passed from starting points to stable points on the energy surface gives a clear perspective on the saving of time for large structures. As shown in Table 2, compared to the 197 total points investigated in the search of a stable LiMnO₂ phase, the trial points of the composite Li(CoNiMn)_{1/3}O₂ Model A are reduced by a factor of 10 if searched using the algorithm-derived structures. A broader range of energy points is avoided for the large composite structure. The rather extensive and expensive QS in our method are used to fine tune the algorithm-derived structures. Furthermore, because of the substantial increase of computing costs required at each structural point of the large model, the total computing costs are significantly reduced. Thus, the algorithm uses only those structures with high probability to be successfully synthesized in an economic and timely manner.

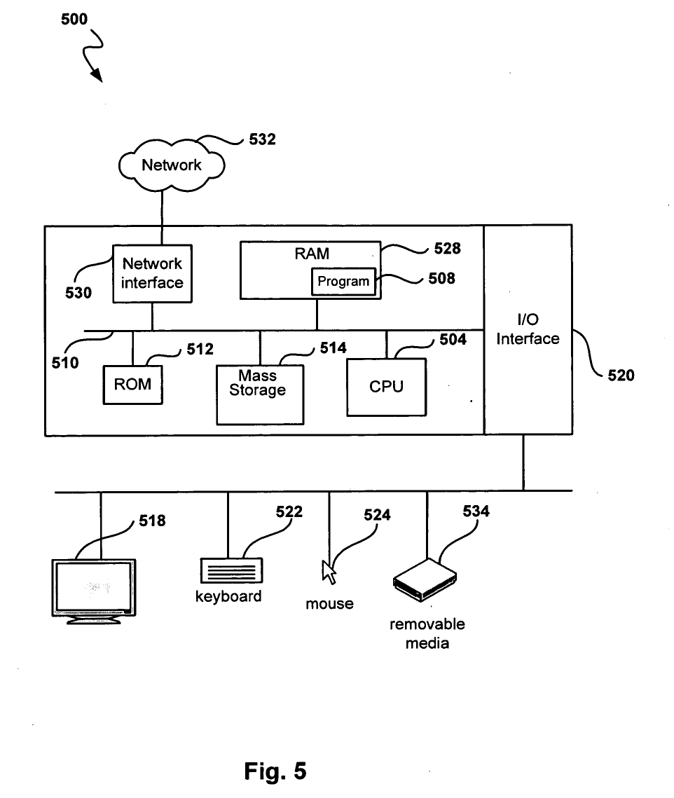

FIG. 5 depicts a computer environment for implementing embodiments of the invention. It should be appreciated that the methods described herein may be performed with a digital processing system, such as a conventional, general-purpose computer system. Special purpose computers, which are designed or programmed to perform only one function may be used in the alternative. The computer system includes a central processing unit (CPU) 504, which is coupled through bus 510 to random access memory (RAM) 506, read-only memory (ROM) 512, and mass storage device 514. Quantum simulation program 508 resides in random access memory (RAM) 506, but can also reside in mass storage 514.

Mass storage device 514 represents a persistent data storage device such as a floppy disc drive or a fixed disc drive, which may be local or remote. Network interface 530 provides connections via network 532, allowing communications with other devices, such as search server 114, community bookmark server 112 as seen in FIG. 1. It should be appreciated that CPU 504 may be embodied in a general-purpose processor, a special purpose processor, or a specially programmed logic device. Input/Output (I/O) interface provides communication with different peripherals and is connected with CPU 504, RAM 506, ROM 512, and mass storage device 514, through bus 510. Sample peripherals include display 518, keyboard 522, cursor control 524, removable media device 534, etc.

Display 518 is configured to display the user interfaces described herein, such as browser 102 from FIG. 1. Keyboard 522, cursor control 524, removable media device 534, and other peripherals are coupled to I/O interface 520 in order to communicate information in command selections to CPU 504. It should be appreciated that data to and from external devices may be communicated through I/O interface 520. The invention can also be practiced in distributed computing environments where tasks are performed by remote processing devices that are linked through a wire-based or wireless network.

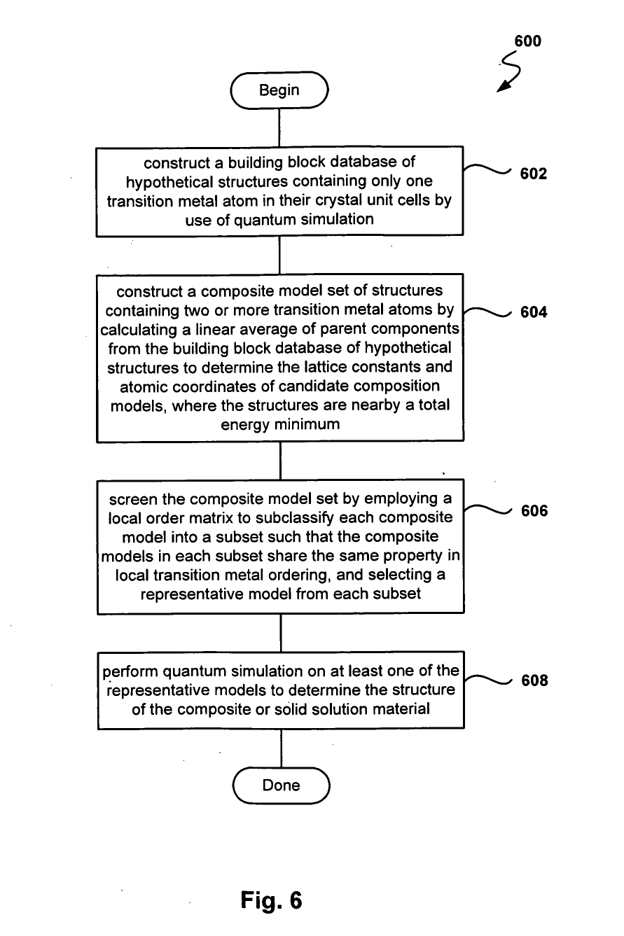

FIG. 6 illustrates a flow chart for a method of determining the structure of a composite or solid solution material for a cathode in a lithium-ion battery. In operation 602, the method constructs a building block database of hypothetical structures containing only one transition metal atom in their crystal unit cells by use of quantum simulation. In operation 604, the method constructs a composite model set of structures containing two or more transition metal atoms by calculating a linear average of parent components from the building block database of hypothetical structures to determine the lattice constants and atomic coordinates of candidate composition models. Te structures are nearby a total energy minimum.

Further, in operation 606 the method screens the composite model set by employing a local order matrix to subclassify each composite model into a subset such that the composite models in each subset share the same property in local transition metal ordering, and selecting a representative model from each subset. In operation 608, the method performs a quantum simulation on at least one of the representative models to determine the structure of the composite or solid solution material.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated that, although specific embodiments of the invention have been described herein for purposes of illustration, various modifications may be made without departing from the spirit and scope of the invention. All such modifications and variations are intended to be included herein within the scope of this disclosure and the present invention and protected by the following claims.

What is claimed is:

1. A method of determining the structure of a composite or solid solution material for a cathode in a lithium-ion battery, the method comprising:
constructing a building block database of hypothetical structures containing only one transition metal atom in their crystal unit cells by use of quantum simulation;
constructing a composite model set of structures containing two or more transition metal atoms by calculating a linear average of parent components from the building block database of hypothetical structures to determine the lattice constants and atomic coordinates of candidate composition models, the structures being nearby a total energy minimum;
screening the composite model set by employing a local order matrix to subclassify each composite model into a subset such that the composite models in each subset share the same property in local transition metal ordering, and selecting a representative model from each subset; and
performing quantum simulation on at least one of the representative models to determine the structure of the composite or solid solution material.

2. The method of claim 1, wherein each of the structures from the composite model set is within 2% of the corresponding quantum simulation optimized structure determined from its representative model.

3. The method of claim 1, wherein each of the structures from the composite model set is within 1% of the corresponding quantum simulation optimized structure determined from its representative model.

4. The method of claim 1, wherein the composite or solid solution material comprises at least one transition metal selected from the group consisting of Sc, Ti, Zr, V, Nb, Cr, Mo, W, Mn, Fe, Co, Ni, Cu, Pd, Pt, Tc, Ru, Rh, Cd, Ag, Au, Y and Zn.

5. The method of claim 1, wherein quantum simulation of the hypothetical structures of the building block database is performed by the density functional theory method or other similar quantum simulation methods.

6. The method of claim 1, wherein quantum simulation of the at least one representative model is performed by the density functional theory method or other similar quantum simulation methods.

7. The method of claim 1, wherein construction of the composite model set of structures is performed with structures containing two or more transition metal ions.

8. The method of claim 1, wherein quantum simulation is performed on two or more of the representative models and the model with the lowest formation energy is selected as the candidate structure for a composite or solid solution material for an electrode in a lithium-ion battery.

9. The method of claim 8, wherein the formation energy is calculated at 30° C. or less.

10. The method of claim 8, wherein the formation energy is calculated at 100° C. or less.

11. The method of claim 8, wherein the formation energy is calculated at 200° C. or less.

12. The method of claim 8, wherein the formation energy is calculated at 1200° C. or less.

13. A method of determining the structure of a composite or solid solution material for a cathode in a lithium-ion battery, the method comprising:
constructing a composite model set of structures containing two or more transition metal atoms by calculating a linear average of parent components from a building block database of hypothetical structures containing only one transition metal atom in their crystal unit cells to determine the lattice constants and atomic coordinates of candidate composition models, the structures being nearby a total energy minimum;
screening the composite model set by employing a local order matrix to subclassify each composite model into a subset such that the composite models in each subset share the same property in local transition metal ordering, and selecting a representative model from each subset; and
performing quantum simulation on at least one of the representative models to determine the structure of the composite or solid solution material.

14. The method of claim 13, wherein each of the structures from the composite model set is within 2% of the corresponding quantum simulation optimized structure determined from its representative model.

15. The method of claim 13, wherein each of the structures from the composite model set is within 1% of the corresponding quantum simulation optimized structure determined from its representative model.

16. The method of claim 13, wherein the composite or solid solution material comprises at least one transition metal selected from the group consisting of Sc, Ti, Zr, V, Nb, Cr, Mo, W, Mn, Fe, Co, Ni, Cu, Pd, Pt, Tc, Ru, Rh, Cd, Ag, Au, Y and Zn.

17. The method of claim 13, wherein quantum simulation of the at least one representative model is performed by the density functional theory method or other similar quantum simulation methods.

18. The method of claim 13, wherein construction of the composite model set of structures is performed with structures containing two or more transition metal ions.

19. The method of claim 13, wherein quantum simulation is performed on two or more of the representative models and the model with the lowest formation energy is selected as the candidate structure for a composite or solid solution material for an electrode in a lithium-ion battery.

20. The method of claim 19, wherein the formation energy is calculated at 30° C. or less.

21. The method of claim 19, wherein the formation energy is calculated at 100° C. or less.

22. The method of claim 19, wherein the formation energy is calculated at 200° C. or less.

23. The method of claim 19, wherein the formation energy is calculated at 1200° C. or less.

24. A method of determining the structure of an alloyed anode material for an electrode in a lithium-ion battery, the method comprising:
constructing a building block database of hypothetical structures containing only one active backbone element in their crystal unit cells by use of quantum simulation;
constructing a composite model set of structures containing two or more active backbone elements by calculating a linear average of parent components from the building block database of hypothetical structures to determine the lattice constants and atomic coordinates of candidate composition models, the structures being nearby a total energy minimum;
screening the composite model set by employing a local order matrix to subclassify each composite model into a subset such that the composite models in each subset share the same property in local active backbone element ordering, and selecting a representative model from each subset; and
performing quantum simulation on at least one of the representative models to determine the structure of the alloyed anode material.

25. The method of claim 24, wherein each of the structures from the composite model set is within 2% of the corresponding quantum simulation optimized structure determined from its representative model.

26. The method of claim 24, wherein each of the structures from the composite model set is within 1% of the corresponding quantum simulation optimized structure determined from its representative model.

27. The method of claim 24, wherein the alloyed anode material comprises at least one active backbone element selected from the group consisting of B, Al, Ga, C, Si, Ge, Sn, N, P, Sb, Bi, O, S, Se, Te, Zn, Cu, Ag and Au.

28. The method of claim 24, wherein quantum simulation of the hypothetical structures of the building block database is performed by the density functional theory method or other similar quantum simulation methods.

29. The method of claim 24, wherein quantum simulation of the at least one representative model is performed by the density functional theory method or other similar quantum simulation methods.

30. The method of claim 24, wherein construction of the composite model set of structures is performed with structures containing two or more active backbone elements.

31. The method of claim 24, wherein quantum simulation is performed on two or more of the representative models and the model with the lowest formation energy is selected as the candidate structure for an alloyed anode material for an electrode in a lithium-ion battery.

32. The method of claim 31, wherein the formation energy is calculated at 30° C. or less.

33. The method of claim 31, wherein the formation energy is calculated at 100° C. or less.

34. The method of claim 31, wherein the formation energy is calculated at 200° C. or less.

35. The method of claim 31, wherein the formation energy is calculated at 1200° C. or less.

36. A method of determining the structure of an alloyed anode material for an electrode in a lithium-ion battery, the method comprising:
constructing a composite model set of structures containing two or more active backbone elements by calculating a linear average of parent components from a building block database of hypothetical structures containing only one active backbone element in their crystal unit cells to determine the lattice constants and atomic coordinates of candidate composition models, the structures being nearby a total energy minimum;
screening the composite model set by employing a local order matrix to subclassify each composite model into a subset such that the composite models in each subset share the same property in local active backbone element ordering, and selecting a representative model from each subset; and
performing quantum simulation on at least one of the representative models to determine the structure of the alloyed anode material.

37. The method of claim 36, wherein each of the structures from the composite model set is within 2% of the corresponding quantum simulation optimized structure determined from its representative model.

38. The method of claim 36, wherein each of the structures from the composite model set is within 1% of the corresponding quantum simulation optimized structure determined from its representative model.

39. The method of claim 36, wherein the alloyed anode material comprises at least one active backbone element selected from the group consisting of B, Al, Ga, C, Si, Ge, Sn, N, P, Sb, Bi, O, S, Se, Te, Zn, Cu, Ag and Au.

40. The method of claim 36, wherein quantum simulation of the at least one representative model is performed by the density functional theory method or other similar quantum simulation methods.

41. The method of claim 36, wherein construction of the composite model set of structures is performed with structures containing two or more active backbone elements.

42. The method of claim 36, wherein quantum simulation is performed on two or more of the representative models and the model with the lowest formation energy is selected as the candidate structure for an alloyed anode material for an electrode in a lithium-ion battery.

43. The method of claim 42, wherein the formation energy is calculated at 30° C. or less.

44. The method of claim 42, wherein the formation energy is calculated at 100° C. or less.

45. The method of claim 42, wherein the formation energy is calculated at 200° C. or less.

46. The method of claim 42, wherein the formation energy is calculated at 1200° C. or less.
